(19) United States
(12) Patent Application Publication
(10) Pub. No.: US 2026/0243627 A1
(43) Pub. Date: Aug. 20, 2026

(54) VIBRATION GENERATING DEVICE FOR SIMULATING BEARING FAULTS

(71) Applicant: AKTIEBOLAGET SKF, GOTEBORG (SE)

(72) Inventors: Nathan WILSON, Dallas, TX (US); John Elliot CARDWELL, III, Harleysville, PA (US)

(21) Appl. No.: 19/058,326

(22) Filed: Feb. 20, 2025

(51) Int. Cl. G01M 13/045

(52) U.S. Cl. CPC G01M 13/045

(57) ABSTRACT

A vibration generating device for simulating a fault in a bearing includes a housing having a cavity and a base attached to or integrally formed with the housing and removably connectable with the bearing to couple the housing with the bearing. A hammer is disposed within the cavity, linearly displaceable along a travel axis, and has a strike end impactable against an anvil surface on an anvil member connected with the base, the base or the bearing. An actuator is disposed within the cavity and configured to displace the hammer along the axis. The actuator preferably reciprocatably displaces the hammer along the axis such that the hammer strike end periodically impacts the anvil surface and generates a vibration signal within the bearing. The actuator is preferably adjustable by a controller to vary a period of the hammer impacts such that a frequency of the vibration signal is increased or decreased.

### BACKGROUND OF THE INVENTION

The present invention relates to bearings, and more particularly to equipment for testing devices or systems for monitoring bearing faults.

It is known to provide condition monitoring equipment which typically includes one or more sensors mounted within or on a rolling element bearing, on a bearing housing or at another location on or within a machine incorporating one or more bearings. Such sensor(s) detect certain faults in the bearing, for example, spalling or galling of the bearing raceways, the presence of contaminants on the raceway(s), misalignment between the shaft and bearing housing, inadequate lubrication, etc. These faults generate vibration within the bearing that is detected by the sensors and then transmitted to appropriate analytical tools to determine the type and severity of the bearing fault. The expectation is that such monitoring equipment will detect any of these faults well prior to a total failure of the bearing, which can cause catastrophic effects to the equipment within which the bearing(s) are incorporated.

Generally, once such bearing monitoring devices are installed within or on a bearing, there is merely an assumption that the device or system will function correctly and detect any bearing faults prior to developing into a serious problem. As certain sensors may be remote from a bearing, it is important that such sensors are capable of detecting any bearing faults regardless of the amplitude of the vibration generated by the fault. To date, there are few known devices or processes for testing the efficacy or accuracy of bearing monitoring equipment.

### SUMMARY OF THE INVENTION

In an aspect, the present invention is a vibration generating device for simulating a fault in a bearing. The device comprises a housing having an interior cavity and a base attached to or integrally formed with the housing and removably connectable with the bearing or a machine incorporating the bearing so as to couple the housing with the bearing or the machine. A hammer is disposed within the cavity, is linearly displaceable along a travel axis and has a strike end impactable against an anvil surface provided on one of an anvil member connected with the base, the base and the bearing. Further, an actuator is disposed within the cavity and is configured to displace the hammer along the travel axis.

Preferably, the actuator is configured to reciprocatably displace the hammer along the travel axis such that the strike end of the hammer periodically impacts the anvil surface and generates a vibration signal within the bearing. Most preferably, the actuator is adjustable so as to vary a period of the hammer impacts such that a frequency of the vibration signal is increased or decreased. To effect this capability, the device preferably further comprises a controller electrically connected with and configured to adjust the actuator so as to establish a desired frequency of the vibration signal. The controller may be operated by an input device mounted on the housing, electrically connected with the controller and configured to generate a control signal receivable by the controller such that the controller adjusts the actuator. Alternatively or additionally, the controller may be configured to receive a control signal from an external device, e.g., an app installed in a smart phone or tablet computer, and the controller adjusts the actuator in response to the control signal. Furthermore, the actuator preferably includes either a solenoid or a motor.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a more diagrammatic, perspective view of a vibration generating device of the present invention, shown mounted on a bearing housing;

FIG. 2 is an axial cross-sectional view of a first preferred construction of the vibration generating device;

FIG. 3 is an enlarged, broken-away view of a lower portion of the first construction device, showing a hammer at an initial position;

FIG. 4 is another enlarged, broken-away view of the lower of the first construction device, shown mounted on a bearing and with the hammer at an impact position;

FIG. 5 is an axial cross-sectional view of a second preferred construction of the vibration generating device;

FIG. 6 is an enlarged, broken-away view of a lower portion of the second construction device, showing a hammer at an initial position;

FIG. 7 is another enlarged, broken-away view of the lower portion of the second construction device, show mounted on a bearing with the hammer at an impact position;

FIG. 8 is an enlarged, broken-away cross-sectional view of an alternative construction of the vibration generating device in which the hammer impacts a base of the device;

FIG. 9 is an enlarged, broken-away cross-sectional view of another alternative construction of the vibration generating device in which the hammer impacts a bearing; and

FIG. 10 is a more diagrammatic view of the vibration generating device connected with an exemplary machine incorporating at least one bearing; and

FIG. 11 is a more diagrammatic view of a machine incorporating a bearing, showing a vibration generating device mounted at three positions with respect to a bearing rotation axis.

### DETAILED DESCRIPTION OF THE INVENTION

Certain terminology is used in the following description for convenience only and is not limiting. The words “lower”, “upper”, “upward”, “down” and “downward” designate directions in the drawings to which reference is made. The words "inner", "inwardly" and "outer", "outwardly" refer to directions toward and away from, respectively, a designated centerline or a geometric center of an element being described, the particular meaning being readily apparent from the context of the description. Further, as used herein, the words "connected" and “coupled” are each intended to include direct connections between two members without any other members interposed therebetween and indirect connections between members in which one or more other members are interposed therebetween. The terminology includes the words specifically mentioned above, derivatives thereof, and words of similar import.

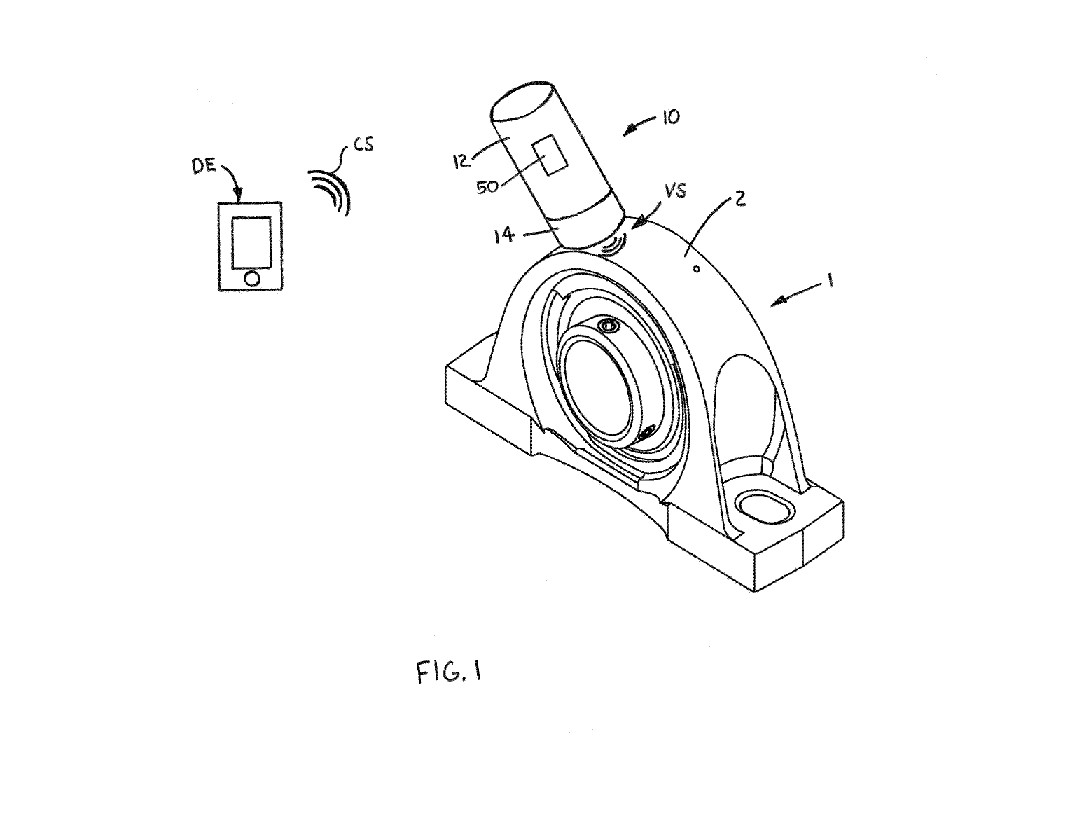

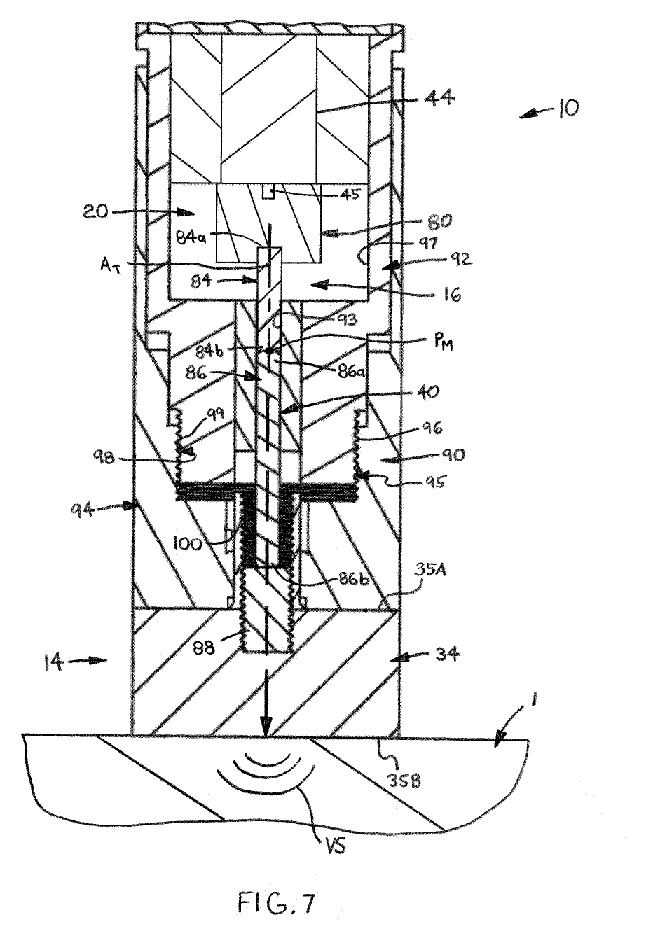

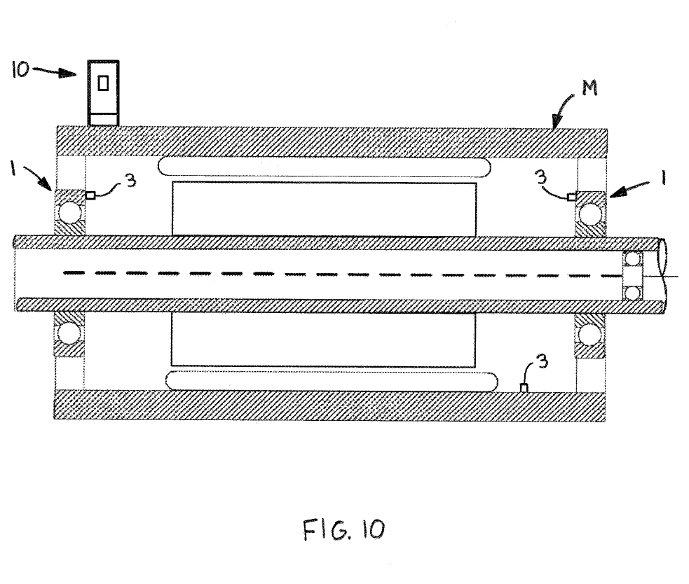

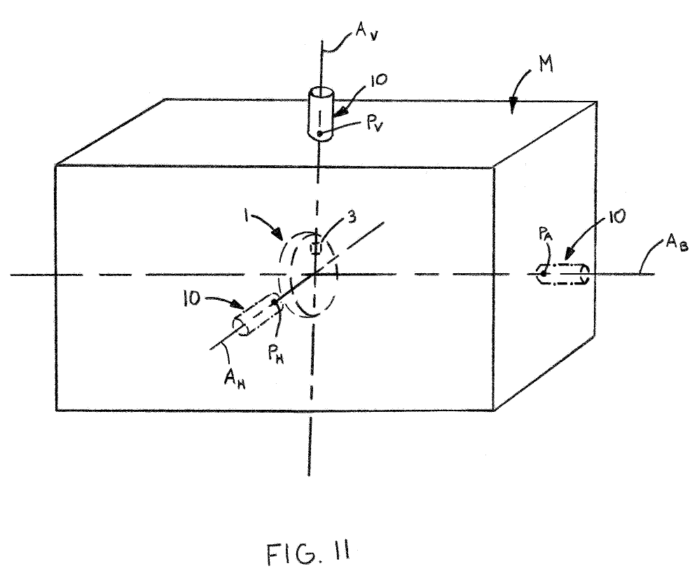

Referring now to the drawings in detail, wherein like numbers are used to indicate like elements throughout, there is shown in FIGS. 1-11 a vibration generating device 10 for simulating a fault in a bearing 1, which enables testing of devices for detecting bearing faults, such as one or more sensors 3 (FIG. 10) mounted within and/or on the bearing 1, or even located remotely from the bearing 1. The device 10 basically comprises a housing 12, a base 14 connectable with the bearing 1 or a machine M (FIGS. 10 and 11) incorporating the bearing 1, a hammer 16 disposed within the housing 12 and impactable against an anvil surface 18 so as to generate a vibration within the bearing 1, and an actuator 20 for displacing the hammer 16. As used herein, the term “machine” includes any known device, apparatus, equipment or structure in which bearings are utilized, such as for example, a motor, a compressor, a vehicle, etc., and any structure associated with and/or supporting the machine. Preferably, the vibration generating device 10 also comprises a controller 22 for adjusting the actuator 20 so as to vary a frequency of a vibration signal VS generated by the hammer impacts, as described in detail below. As a result, the device 10 enables the simulation of expected or known potential bearing defects for a variety of bearing sizes, as also discussed in further detail below.

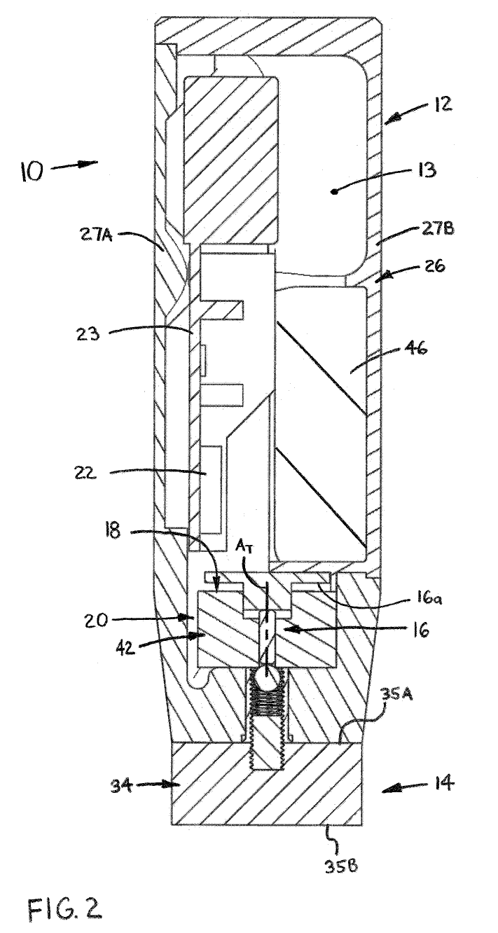

More specifically, the housing 12 has an interior cavity 13 and is preferably either formed as a solid or fixed body 26 including two connected shell portions 27A, 27B (FIGS. 2-4) or as an adjustable or movable body 28 including a first, upper body portion 92 and a second, lower body portion 94 which are adjustably connected for reasons described in further detail below. In either construction, the housing 12 is preferably formed of a molded polymeric material or an extruded or stamped metal (e.g., aluminum), but may be formed of any appropriate material in any known process, such as additive manufacturing. Although the drawings depict two presently preferred constructions, the housing 12 may alternatively be formed of any desired shape, of any desired number of connected body portions and/or in any other manner that enables the vibration generating device 10 to function as described herein.

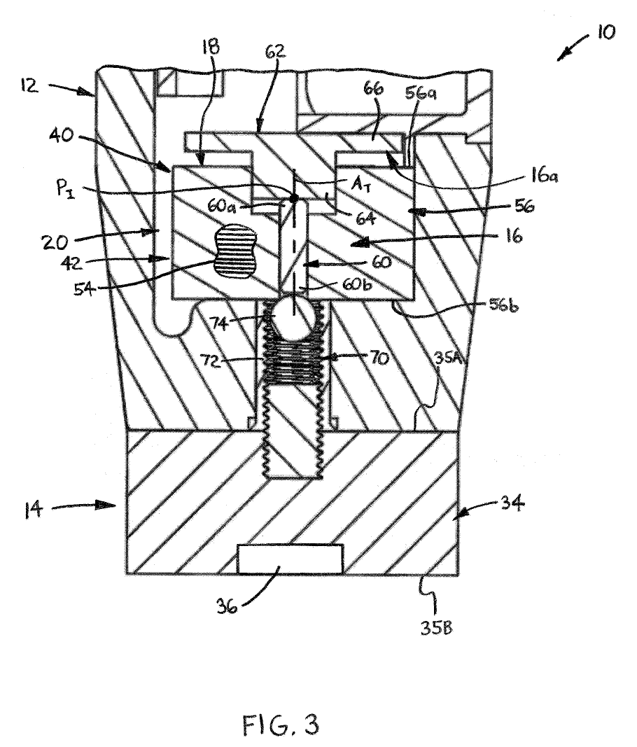

Further, the base 14 is preferably attached to, but may be integrally formed, with the housing 12 and is removably connectable with the bearing 1 or the machine M so as to couple the device 10 with the bearing 1 or the machine M. By being removably connectable to the bearing 1, preferably to a bearing housing 2 (FIG. 1), which is considered to be part of the bearing 1 for purposes of the present disclosure, or a bearing outer ring (not shown), the base 14 enables the vibration generating device 10 to be readily mountable on a variety of different bearings 1 or machines M. Preferably, the base 14 is formed as a cylindrical block 34 having a first, upper surface 35A and a lower surface 35B disposable against the bearing 1. The block 34 is preferably formed of a magnetic material, but may alternatively include at least one magnet 36 attached to the block 34 as depicted in FIG. 3. In either case, the base 14 is magnetically coupleable with the bearing 1 merely by placing the lower surface 35B of the base block 34 against an outer surface of a portion of the bearing 1, the bearing housing 2 or the machine M, which are typically formed of ferromagnetic materials. However, the base 12 may be formed or include any other features for removably connecting the vibration generating device to a bearing 1, such as for example, a suction device, a pad of a hook and loop material engageable with a corresponding pad attached to the bearing 1, etc.

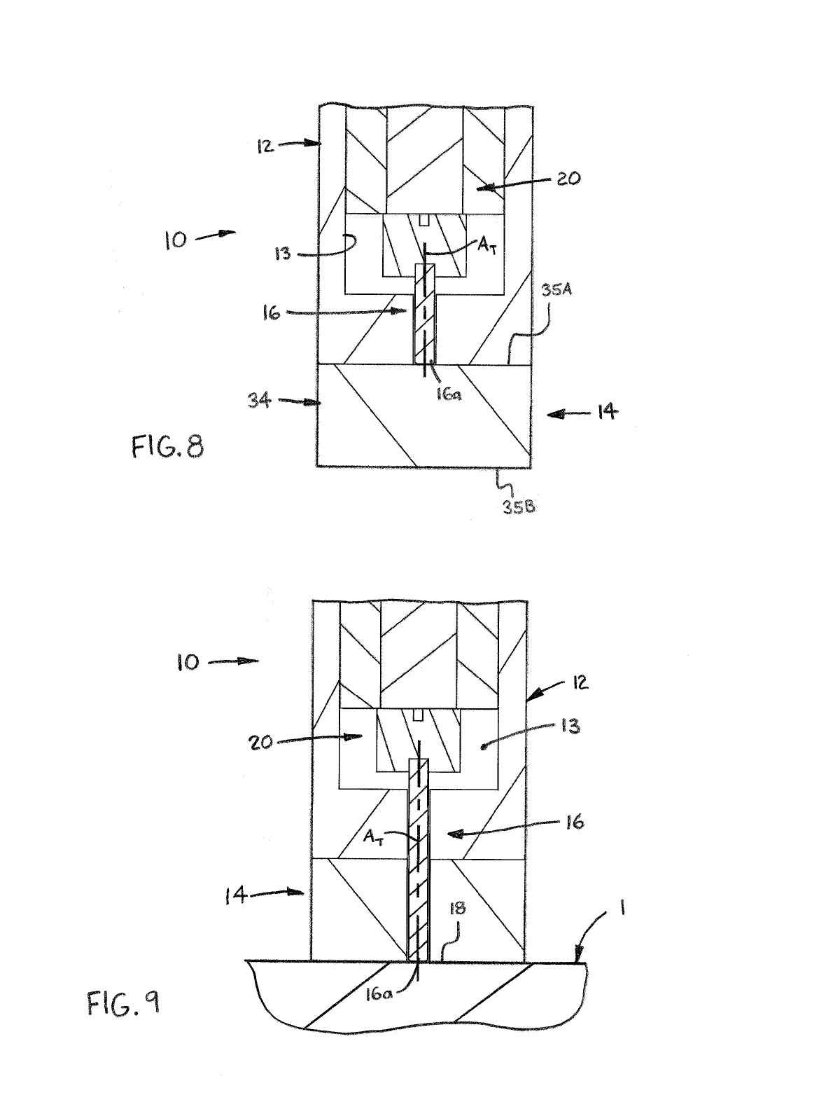

Furthermore, the hammer 16 is disposed within the cavity 13 of the housing 12 and is linearly displaceable along a travel axis A_{T}, which preferably extends generally centrally through the housing 12 and generally perpendicular to the upper surface 35A of the base block 34. The hammer 16 has a strike end 16a impactable against the anvil surface 18 provided on an anvil member 40 connected with the base 14, on the base 12 (FIG. 8) or on the bearing 1 (FIG. 9). In any case, the impact of the hammer strike end 16a on the anvil surface 18 generates a vibration signal VS which may pass through components of the device 10 or be directly generated in the bearing 1, as described in detail below.

Preferably, the hammer 16 is reciprocatably displaceable between an initial position P_{I}, at which the strike end 16a of the hammer 16 is spaced from the anvil surface 18, and an impact position P_{M} at which the strike end 16a of the hammer 16 contacts the anvil surface 18. As used herein, a “hammer impact period” means a period of time between two successive impacts of the hammer 16 on the anvil surface 18, i.e., the amount of time for the hammer 16 to displace from the impact position P_{M} to the initial position P_{I} and back to the impact position P_{M}. Although the hammer 16 is preferably reciprocatable as described herein, the hammer 16 may be configured to impact the anvil surface 18 in a single or discrete movement between the two positions P_{I}, P_{M}.

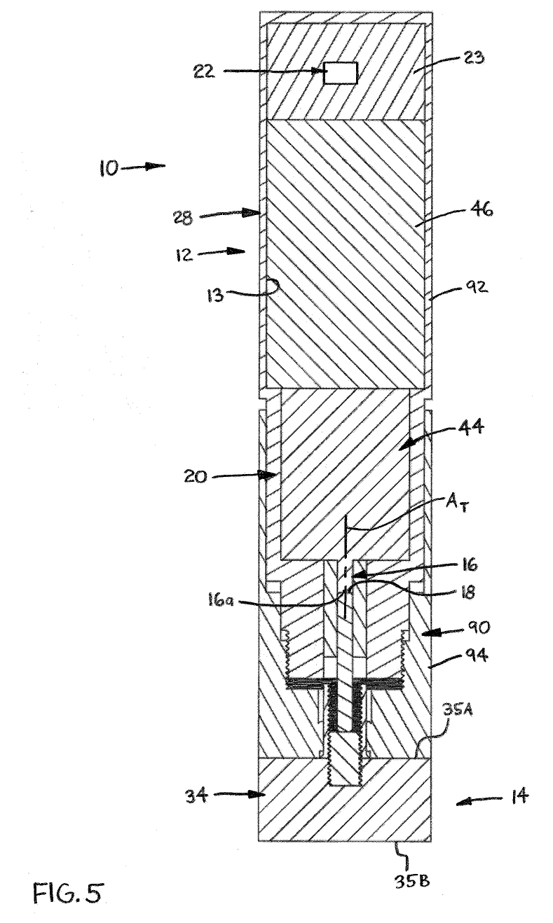

Referring to FIGS. 2-9, the actuator 20 is disposed within the cavity 13 and is configured to displace the hammer 16 along the travel axis A_{T}. Preferably, the actuator 20 is configured to reciprocatably displace the hammer 16 along the axis A_{T}, i.e., between the initial and impact positions P_{I}, P_{M}, as described above. Thereby, the strike end 16a of the hammer 16 periodically impacts the anvil surface 18 and generates the vibration signal VS within the bearing 1 as mentioned above. In two presently preferred constructions described below, the actuator 20 either includes a solenoid 42 (FIGS. 2-4) or a motor 44 (FIGS. 5-7), but may include any other appropriate, known type of actuator capable of operating the hammer 16 generally as described herein.

Further, the actuator 20 is preferably adjustable, most preferably by means of the controller 22 as described below, so as to vary the hammer impact period as defined above. Such variation of the hammer impact period either increases or decreases a frequency of the vibration signal VS. When the actuator 20 includes a solenoid 42, the actuator 20 is adjustable by varying the rate at which current is applied to the coil 54 of the solenoid 42 (e.g., 0.5 second, every 1 second, etc.) so as adjust the speed or rate of armature displacement, which forms part of the hammer 16, as described below. Alternatively, when the actuator 20 includes a motor 44, the actuator 20 is adjustable by adjusting the current flow through the motor coil(s) (none shown) so as to adjust the speed of motor shaft rotation, as also discussed in further detail below.

Although the actuator 20 is preferably adjustable, the actuator 20 may be configured so as to operate at a single speed, either at a fixed period of solenoid operation or a fixed speed of motor shaft rotation. Further, the actuator 20 may alternatively be configured to only operate the hammer 16 to provide a single impact or to impact the anvil surface 18 in an uneven or irregular manner, such that a continuous vibration signal is not generated within the bearing 1.

Furthermore, with any structure of the actuator 20 as described above, the vibration generating device 10 preferably further comprises a power supply 46 disposed within housing cavity 13 (as depicted), or attached to the housing 12 (not shown), and electrically connected with the actuator 20. The power supply 46 is preferably an appropriate battery, but may include a power converter (not shown) connectable to source of AC or DC current.

As discussed above, the vibration generation device 10 preferably includes the controller 22, most preferably mounted on a circuit board 23, which is electrically connected with and configured to adjust the actuator 20 so as to establish a desired frequency of the vibration signal VS, specifically by varying the hammer displacement period as discussed above. Preferably, the controller 22 includes a memory (not indicated) with stored values of different hammer frequencies, which simulate known defects of bearings of various diametrical and axial sizes and/or different bearing types and constructions, and a means for selecting such different hammer frequencies.

Referring particularly to FIG. 1, the vibration generating device 10 preferably includes an input device 50 mounted on the housing 12 and electrically connected with the controller 22, such as for example, a button, a panel of buttons, a touch screen, etc. The input device 50 is configured to generate at least one control signal CS receivable by the controller 22 such that the controller 22 adjusts the actuator 20 to operate the hammer 16 at a desired period of operation, and may do so by enabling the selection of one of the stored values within the controller memory. Alternatively, the controller 22 may be configured to receive a control signal CS from an external device DE (FIG. 1), such as a laptop computer, a tablet computer, a smart phone, etc., and the controller 22 adjusts the actuator in response to the control signal. Such a control signal CS may be sent wirelessly, for example utilizing Bluetooth technology or any other appropriate wireless transmission protocol.

With the vibration generating device 10 of the present invention as described above, a user is able to readily mount the device 10 to a bearing 1 merely by placing the base 14 against a surface of the bearing housing 2 or the bearing outer ring (not shown). Then, the user may operate the device 10 using either the input device 50 or the external device DE such that the actuator 20 displaces the hammer 14 at a desired hammer impact period, which is preferably selected to simulate a particular defect in the specific size and type of bearing 1. The vibration signals VS generated by the device 10 should then be detected by the sensors or other devices used to monitor the bearing 1 (none shown). As such, the present vibration generating device 10 provides a means to test whether or not the bearing monitoring equipment is functioning correctly.

Having described the basic components and functions above, these and other element of the vibration generating device 10 are described in further detail below. In particular, two presently preferred constructions of device 10, a first “low speed” device 10 in which the actuator 20 includes a solenoid 40 and a second, “high speed” device 10 incorporating a motor 44 in the actuator 20, are described in detail below.

Referring now to FIGS. 2-4, the first presently preferred construction of the vibration generating device 10 is a “low speed” device in which the actuator 20 includes a solenoid 42. Specifically, the solenoid 42 includes a coil 54 disposed within an annular solenoid housing 56 and the hammer 16 includes a pin 60 extending through the coil 54. The solenoid housing 56 has a first, upper end 56a providing the anvil surface 18 and a second, lower end 56b disposed against a portion of the housing 12 interposed disposed between the actuator 20 and the base 14. The hammer pin 60 has a first, upper end 60a and an opposing second, lower 60b disposed within the coil 54.

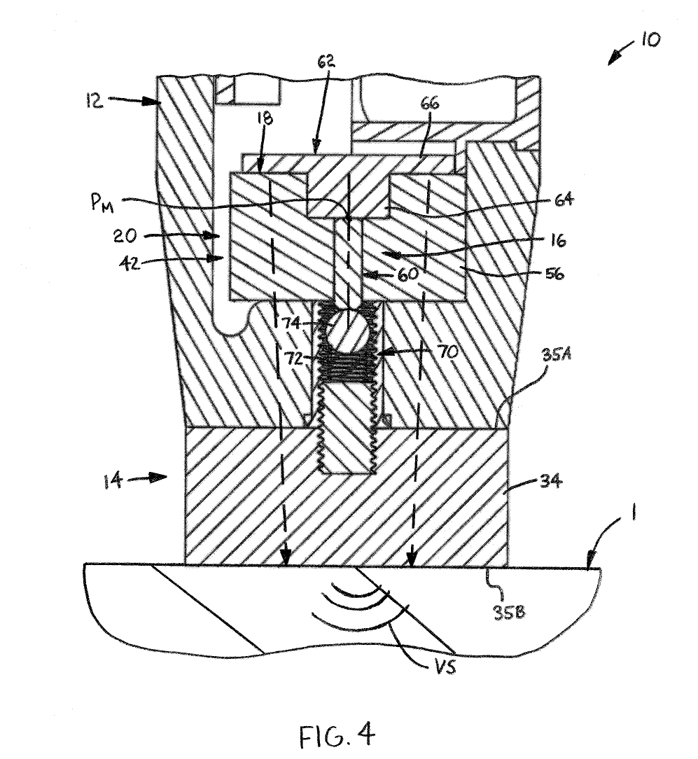

Further, the hammer 14 also includes an annular strike member 62 with a central hub 64 attached to or disposed against the first, upper end 60a of the pin 60 and a flange 66 extending radially from the hub 64. The flange 66 provides the strike end 16a of the hammer 16 and is impactable against the first end 56a of the solenoid housing 56. As such, when the annular flange 66 impacts against the upper end 56a of the solenoid housing 56, a vibration signal VS is transmitted through the solenoid housing 56, through the portion of the housing 12 between the solenoid housing 56 and the base 14, and through the base 14 so as to enter the bearing 1, as indicated in FIG. 4.

As with any solenoid, energization of the coil 54 is only capable of linearly displacing the pin 60 and the strike member 62 in one linear direction, specifically from the initial position P_{I} (FIG. 3) to the strike position P_{M} (FIG. 4). Therefore, in the first construction of the device 10, the actuator 20 further includes a biasing member 70 configured to displace the hammer 16 from the impact position P_{M} to the initial position P_{I}. Specifically, the biasing member 70 includes a spring 72, preferably a coil spring, extending between the base 14 and the hammer 16 and a contact member 74, preferably a ball, disposed between the spring 72 and the pin 60 of the hammer 16. With this structure, the spring 72 is compressed when the hammer 16 is displaced to the impact position P_{M} and is freed to bias the hammer 16 to the initial position P_{I} when the solenoid coil 54 is deenergized. The contact member 74 is provided to facilitate engagement between the second end 60b of the hammer pin 60 and the spring 72.

Referring now to FIGS. 5-7, in the second preferred construction, the actuator 20 includes the motor 44, as discussed above, and is capable of achieving relatively higher speeds of hammer displacement in comparison with the first construction. In the second construction, the actuator 20 further includes a rotation-to-linear (hereinafter “RTL”) converter 80 coupled with the hammer 16 and configured to reciprocatably displace the hammer 16 along the travel axis A_{T}. Specifically, the motor 44 has a rotatable shaft 45 and the RTL converter 80 is coupled with both the rotatable shaft 45 and the hammer 16 such that rotation of the shaft 45 causes reciprocating linear displacement of the hammer 16 along the travel axis A_{T}.

As mechanisms for converting rotational motion into linear displacement are well known in the art of mechanical engineering, the RTL converter 80 is not described in detail herein. However, it must be noted that the RTL converter 80 of the present vibration generating device 10 may include any known type of mechanism, such as for example, a crank-slider, a swashplate, a scotch yoke, etc. and the scope of the present invention encompasses any known appropriate mechanism for the RTL converter that enables the actuator 20 to function generally as described herein.

Further, in the second preferred construction, the hammer 16 includes a pin 84 having a first end 84a coupled with the rotation-to-linear converter 80 and a second end 84b providing the strike end 16a of the hammer 16. Specifically, the second end 84b of the hammer pin 84 is impactable against the first end 86a of an elongated rod 86 providing an anvil member 40. The elongated rod 86 has a second end 86b disposed against the base 14, preferably against a set screw 88 attached to the base block 34.

With this structure, rotation of the motor shaft 45 is converted into reciprocating linear displacement of the hammer pin 84 by means of the RTL converter 80 such that second end 84b of the pin 84 repeatedly impacts against the first end 86a of the elongated rod 86. The force of these hammer impacts is transferred through the rod 86, through the set screw 88, through the base block 34 and into the bearing 1. Thereby, a vibration signal passes through the bearing 1, the frequency of the vibration signal being adjustable by means of proportionally adjusting the speed of motor rotation; i.e., increasing the motor rotation speed increasing the vibration signal frequency, and vice-versa.

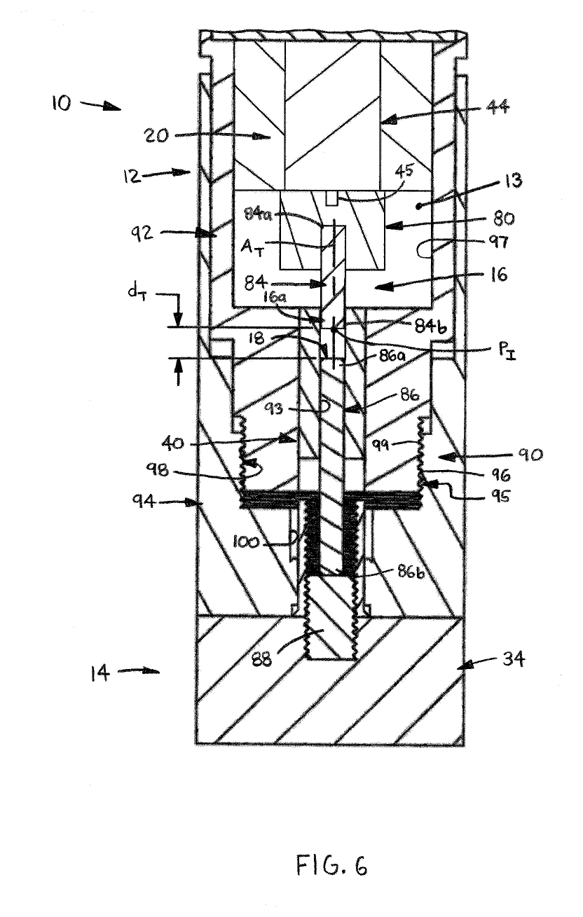

Further, in order to adjust the amplitude of the vibration signal, the second construction of the vibration generating device 10 further comprises an adjustment device 90, which is preferably incorporated into the housing 12. The adjustment device 90 is disposed between the base 14 and the actuator 20 and is configured to vary a travel distance d_{T} (FIG. 6) between the hammer initial position P_{I} and the impact position P_{M}. Preferably, the adjustment device 90 includes a first adjustment member 92 connected with or integrally formed with the housing 12 and a second adjustment member 94 connected with the base 14, the two members 90, 92 being adjustably coupled together and preferably forming the housing 12.

Specifically, the first adjustment member 92 is generally cylindrical and has a bore 93 and a lower portion with an outer circumferential surface 95 having at least one external thread 96, the hammer pin 84 being at least partially disposed within the bore 93, as well as the anvil member rod 86. Preferably, the first adjustment member 92 also has an upper cavity 97 within which is installed the motor 44 and the RTL converter 80. Further, the second adjustment member 94 is also generally cylindrical and has an upper portion with an inner circumferential surface 98 having at least one internal thread 99 engaged with the at least one external thread 96 of the first member 92, and preferably has a central bore 100 through which extends the anvil member rod 86. As such, rotation of the first member 90 with respect to the second member 92 displaces the first member 90 along the hammer travel axis A_{T} so as vary the travel distance d_{T}. When the travel distance d_{T} is increased, the impact force of the hammer pin 84 against the anvil member rod 86 is increased, which increases the amplitude of the vibration signal VS and, conversely, decreasing the travel distance DT decreases the impact force of the hammer pin 84 and the amplitude of the vibration signal VS decreases.

Although two presently preferred constructions of the vibration generating device 10 as disclosed in detail herein, the device 10 may formed in any other appropriate manner that is capable of functioning generally as described herein. For example, the actuator 20 may include a pneumatic motor and be connectable to a source of compressed air, the hammer 16 may be provided by the armature pin of a solenoid which is arranged to directly impact the bearing 1 or an elongated rod attached to the base 14, etc.

Regardless of the specific construction, the vibration generating device 10 of the present invention may be used to test condition monitoring equipment for a bearing 1, such equipment typically including at least one sensor 3 for detecting defects within the bearing 1. The one or more sensors 3 may each be mounted proximal to or on the bearing 1 or remotely from the bearing(s) 1, both arrangements being depicted in FIG. 10. Preferably, testing of the monitoring equipment is conducted upon or within a relatively short period after installation of the equipment in order to verify the proper functioning thereof and includes “commissioning” the sensor(s) 3. Specifically, a sensor 3 is commissioned by ensuring that it is installed correctly and properly connected to associated analytical equipment, and includes verifying proper orientation in order to detect vibration or other noise originating from a specific direction.

To initiate the testing, the vibration generating device 10 (or another device for automatically generating impacts and thereby vibration) is first mounted either directly to a bearing 1 or to a machine M incorporating one or more bearings 1 and is then operated so as to generate a vibration signal VS. Specifically regarding the present device 10, operation of the actuator 20 is initiated using either the input device 50 or an external device DE so that the hammer 16 impacts the anvil surface 18, preferably periodically as described above. As the vibration signals VS pass through the machine M and/or the bearing 1, the one or more sensors 3 should detect the vibration signals VS, the detection of which may be determined by a computer, a controller or other monitoring device coupled with the sensor(s) 3. If it is determined that the signals VS are not detected by one or more of the sensors 3, a fault analysis operation may be performed on the sensor(s) 3 and/or communication equipment (e.g., wires, transmitters, etc.) coupling the sensors 3 with the associated monitoring devices.

With the vibration generating device 10 of the present invention, a person conducting testing may vary the frequency and/or amplitude of the vibration signals VS generated by the device 10 in order to simulate different bearing faults or other conditions within the machine M. Then, the tester may determine through any appropriate means whether or not each one of the vibration signals VS of various frequencies and/or amplitudes are detected by each of the one or more sensors 3. As certain sensors 3 may be located remotely from a bearing 1, it is important to confirm that such sensor(s) 3 are capable of detecting even low amplitude vibration signals, which may be present at the beginning of a fault condition. Also, by adjusting the amplitude of the vibration signal VS, it is possible to test various sensitivities of the monitoring equipment and to therefore make any adjustments as required.

Further, the particular device used to generate vibration signals may be mounted at two or more different locations on the bearing 1 and/or on the machine M to determine whether or not the sensor(s) 3 are able to detect vibration signals VS generated at different locations within the machine M, as each of the one or more sensors 3 may be intended to monitor more than one bearing 1. Additionally, the orientation of the one or more sensors 3, or of the specific instruments (not depicted) within a sensor 3, may be verified by mounting the vibration generating device 10 at each one of three angular positions P_{A}, P_{H} and P_{V} with respect to the sensors 3 or the sensor instruments.

More specifically, the device 10 may be mounted, in whatever desired order, at a first position P_{A} aligned along a rotation axis A_{B} of the bearing 1, at a second position P_{H} aligned along a horizontal axis A_{H} extending perpendicular to the rotation axis A_{B}, and at a third position P_{V} aligned along a vertical axis A_{V} extending perpendicular to the rotation axis A_{B}, as depicted in FIG. 11. The device 10 is operated when mounted at each one of the first position P_{A}, the second position P_{H} and the third position P_{V} and the appropriate monitoring equipment determines whether the vibration signal VS generated at each position P_{A}, P_{H}, P_{V} is detected, and preferably also the amplitude of each signal VS detected.

As such, a tester may determine the alignment of the sensor(s) 3, particularly during a commissioning process, by whether or not a vibration signal VS generated at each position P_{A}, P_{H}, P_{V} is detected or at which position P_{A}, P_{H} or P_{V} the amplitude of the signal VS is greatest. In other words, a sensor 3 is aligned in a particular direction when only detecting a signal VS generated at one of the three positions P_{A}, P_{H}, P_{V} or when the sensor 3 detects a signal VS with the greatest amplitude when the device 10 is located at a particular one of the positions P_{A}, P_{H}, and P_{V}. Further, when a sensor 3 is triaxial and has three instruments each detecting a vibration signal VS from a separate one the three directions (i.e., axial, horizontal and vertical), the detection of vibration signals VS generated at each position P_{A}, P_{H}, P_{V} may confirm whether or not each instrument is properly connected with the associated monitoring equipment.

Furthermore, it must be noted that an automated impacting device, such as the vibration generating device 10 of the present invention, more accurately simulates a bearing fault signal as opposed to a device that generates a sinusoidal signal. Also, due to the relatively lightweight design of the present vibration generating device 10, the device 10 at most only minimally effects the natural response characteristics of the bearing 1 and/or the machine M incorporating the monitoring equipment being tested.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A vibration generating device for simulating a fault in a bearing, the device comprising:
a housing having an interior cavity;
a base attached to or integrally formed with the housing and removably connectable with the bearing or a machine incorporating the bearing so as to couple the housing with the bearing or the machine;
a hammer disposed within the cavity, linearly displaceable along a travel axis and having a strike end impactable against an anvil surface provided on one of an anvil member connected with the base, the base and the bearing; and
an actuator disposed within the cavity and configured to displace the hammer along the axis.

2. The device as recited in claim 1, wherein the actuator is configured to reciprocatably displace the hammer along the axis such that the strike end of the hammer periodically impacts the anvil surface and generates a vibration signal within the bearing.

3. The device as recited in claim 2, wherein the actuator is adjustable so as to vary a period of the hammer impacts such that a frequency of the vibration signal is increased or decreased.

4. The device as recited in claim 3, further comprising a controller electrically connected with and configured to adjust the actuator so as to establish a desired frequency of the vibration signal.

5. The device as recited in claim 4, wherein one of:
the device further comprises an input device mounted on the housing, electrically connected with the controller and configured to generate a control signal receivable by the controller such that the controller adjusts the actuator; and
the controller is configured to receive a control signal from an external device and the controller adjusts the actuator in response to the control signal.

6. The device as recited in claim 1, wherein the actuator includes a solenoid or a motor.

7. The device as recited in claim 1, wherein the hammer is reciprocatably displaceable between an initial position at which the strike end of the hammer is spaced from the anvil surface and an impact position at which the strike end of the hammer contacts the anvil surface.

8. The device as recited in claim 7, wherein:
the actuator includes a solenoid configured to displace the hammer from the initial position to the impact position; and
the device further comprises a biasing member configured to displace the hammer from the impact position to the initial position.

9. The device as recited in claim 8, wherein:
the solenoid includes a coil disposed within a solenoid housing, the solenoid housing having a first end providing the anvil surface and a second end disposed against a portion of the housing interposed between the actuator and the base; and
the hammer includes a pin extending through the coil, the pin having a first end and a second end, and an annular strike member having a central hub attached to or disposed against the first end of the pin and a flange extending radially from the hub and providing the strike end of the hammer, the flange being impactable against the first end of the solenoid housing such that a vibration signal is transmitted through the solenoid housing, through the portion of the housing interposed between the solenoid housing and the base, and through the base so as to enter the bearing.

10. The device as recited in claim 9, wherein the biasing member includes a spring extending between the base and the hammer and a contact member disposed between the spring and the pin of the hammer.

11. The device as recited in claim 7, wherein the actuator includes a motor and a rotation-to-linear converter coupled with the hammer and configured to reciprocatably displace the hammer along the travel axis.

12. The device as recited in claim 11, wherein:
the anvil member includes an elongated rod having first and second ends, the first end providing the anvil surface and the second end being disposed against the base; and
the hammer includes a pin having a first end coupled with the rotation-to-linear converter and a second end impactable against the first end of the elongated rod.

13. The device as recited in claim 1, further comprising an adjustment device disposed between the base and the actuator and configured to vary a travel distance between the initial position and the impact position.

14. The device as recited in claim 13, wherein the adjustment device includes:
a first member connected with or integrally formed with the housing, the first member having a bore and an outer circumferential surface with at least one external thread, the hammer being at least partially disposed within the bore; and
a second member connected with the base and having an inner circumferential surface with at least one internal thread engaged with the at least one internal thread of the first member such that rotation of the first member with respect to the second member displaces the inner member along the hammer axis so as vary the travel distance.

15. The device as recited in claim 1, wherein the base is formed of a magnetic material or includes at least one magnet such that the base is magnetically coupleable with the bearing.

16. The device as recited in claim 1, further comprising a power supply disposed within housing cavity or attached to the housing and electrically connected with the actuator.

17. The device as recited in claim 1, further comprising a controller electrically connected with and configured to adjust actuator such that the actuator varies a rate of displacement of the hammer.

18. A method of testing condition monitoring equipment for a bearing, the monitoring equipment including at least one sensor for sensing defects within the bearing, the method comprising the steps of:
providing a vibration generating device configured to generate a vibration signal;
mounting the device to the bearing or a machine incorporating the bearing;
operating the device so as to generate a vibration signal; and
determining whether the at least one sensor detects the vibration signal.

19. The method as recited in claim 18, wherein:
the vibration generating device includes a housing having an interior cavity, a base attached to or integrally formed with the housing and removably connectable with the bearing or the machine incorporating the bearing so as to couple the housing with the bearing or the machine, a hammer disposed within the cavity, linearly displaceable along a travel axis and having a strike end impactable against an anvil surface provided on one of an anvil member connected with the base, the base and the bearing, and an actuator disposed within the cavity and configured to displace the hammer along the axis; and
the step of operating the device includes the substep of initiating operation of the actuator such that the hammer impacts the anvil surface.

20. The method as recited in claim 18, wherein the step of operating the vibration generating device includes varying a frequency and/or amplitude of the vibration signal generated by the device.

21. The method as recited in claim 20, wherein the step of determining whether the at least one sensor detects the vibration signal includes determining whether the sensor detects signals of differing frequency and/or amplitude.

22. The method as recited in claim 18, wherein:
the step of mounting the device to the bearing or the machine includes mounting the device at one position on the bearing or the machine; and
the method further comprises the steps of:
mounting the device to at least one other position on the bearing or the machine;
operating the device at the other position so as to generate another vibration signal; and
determining whether the at least one sensor detects the other vibration signal.

23. The method as recited in claim 18, wherein:
the step of mounting the device onto the bearing or the machine includes the substeps of mounting the device at a first position aligned along a rotation axis of the bearing, at a second position aligned along a horizontal axis extending perpendicular to the rotation axis, and at a third position aligned along a vertical axis extending perpendicular to the rotation axis;
the step of operating the device includes operating the device when the device is mounted at each one of the first position, the second position and the third position; and
the step of determining whether the at least one sensor detects the vibration signal includes determining whether the sensor detects the vibration signal at each one of the first position, the second position and the third position.
